(19) United States
(12) Patent Application Publication
(10) Pub. No.: US 2025/0189370 A1
(43) Pub. Date: Jun. 12, 2025

(54) SOLID-STATE IMAGING DEVICE

(71) Applicant: Samsung Electronics Co., Ltd., Suwon-si (KR)

(72) Inventor: Seiji YAMAHIRA, Yokohama (JP)

(73) Assignee: Samsung Electronics Co., Ltd., Suwon-si (KR)

(21) Appl. No.: 18/975,151

(22) Filed: Dec. 10, 2024

(30) Foreign Application Priority Data
Dec. 12, 2023 (JP) 2023-209047
Nov. 28, 2024 (KR) 10-2024-0173950

(51) Int. Cl. G01J 1/44; H04N 25/47; H04N 25/50; H04N 25/77

(52) U.S. Cl. CPC G01J 1/44; H04N 25/47; H04N 25/50; H04N 25/77; G01J 2001/442; G01J 2001/4466

(57) ABSTRACT

A solid-state imaging device includes a plurality of pixel blocks, wherein each pixel block of the plurality of pixel blocks includes a plurality of single-photon avalanche diode (SPAD) pixels configured for imaging, and at least one SPAD pixel of the plurality of SPAD pixels includes a detection circuit configured to detect a variation of light incident on the plurality of SPAD pixels.

### CROSS-REFERENCE TO RELATED APPLICATION

This U.S. non-provisional application claims priority under 35 U.S.C. § 119 to Japanese Patent Application No. 2023-209047, filed on Dec. 12, 2023, in the Japanese Patent Office, and Korean Patent Application No. 10-2024-0173950, filed on Nov. 28, 2024, in the Korean Patent Office. The disclosures of both these applications are incorporated herein in their entirety by reference.

### BACKGROUND

Example embodiments of the inventive concepts relate to a solid-state imaging device.

Solid-state imaging devices (e.g., image sensors) may include a single-photon avalanche diode (SPAD) that uses avalanche amplification where a plurality of carriers are generated when one photon is incident on a PN junction to which a reverse bias greater than a breakdown voltage is applied in an avalanche photodiode (APD). In solid-state imaging devices including an SPAD, a plurality of SPAD pixels may be arranged in a row direction and a column direction and each SPAD pixel may include an APD. Solid-state imaging devices including an SPAD may count a pulse generated from a carrier, based on avalanche amplification in the APD, to form an image.

Solid-stage imaging devices may include a pixel array unit including a plurality of pixel blocks, and each of the pixel blocks of the pixel array unit may include a detection pixel and a plurality of count pixels. The detection pixel may detect a variation of incident light, and the count pixel may count an incident photon by using an APD. The detection pixel may include a photodiode (PD) and may notify of an ON event and an OFF event. The ON event may be indicative of the amount of variation in a property of incident light being greater than an upper limit, and the OFF event may be indicative of the amount of variation in the property of incident light being less than a lower limit.

However, spatial resolving power in imaging techniques using a solid-state imaging device may be reduced since the solid-state imaging device may be difficult to count photons in the detection pixel. Also, because a device configuration and a driving voltage of SPADs may differ from those of PDs, there may be a disadvantage in which development and/or manufacturing of solid-state imaging devices may require specialized devices, circuits, and/or equipment and this may increase costs.

### SUMMARY

Example embodiments are directed to a solid-state imaging device which may prevent or minimize reduction in (or otherwise, preserve) spatial resolution in an image and may reduce and/or minimize the number of processes and complexity in manufacturing the solid-state imaging devices.

According to some example embodiments, a solid-state imaging device includes a plurality of pixel blocks, wherein each pixel block of the plurality of pixel blocks includes a plurality of single-photon avalanche diode (SPAD) pixels configured for imaging, and at least one SPAD pixel of the plurality of SPAD pixels includes a detection circuit configured to detect a variation of light incident on the plurality of SPAD pixels.

According to some example embodiments, a solid-state imaging device includes a plurality of pixel blocks, wherein each pixel block of the plurality of pixel blocks includes a plurality of single-photon avalanche diode (SPAD) pixels configured for imaging, at least one SPAD pixel of the plurality of SPAD pixels includes a detection circuit configured to detect a variation of incident light, and the other SPAD pixels of the plurality of SPAD pixels each include a count circuit configured to count a number of incident photons.

According to some example embodiments, a solid-state imaging device includes a driver configured to generate a plurality of signals, a pixel array unit configured to receive the plurality of signals from the driver and including a plurality of single-photon avalanche diode (SPAD) pixels, and a pixel processor configured to execute pixel processing to output a processing result, wherein at least one SPAD pixel of the plurality of SPAD pixels includes a detection circuit configured to detect a variation of light incident on the at least one SPAD pixel, at least one SPAD pixel of the plurality of SPAD pixels includes a count circuit configured to count a photon incident on the at least one SPAD pixel, and the detection circuit is configured to compare a count value of a previous frame with a count value of a current frame to detect the variation of the light.

### BRIEF DESCRIPTION OF THE DRAWINGS

The above and other aspects, features and other advantages of the example embodiments will be more clearly understood from the following detailed description, taken in conjunction with the accompanying drawings.

FIG. 1 is a block diagram illustrating a configuration of a solid-state imaging device, according to some example embodiments.

FIG. 2 is a block diagram illustrating a configuration of a pixel block included in a pixel array unit illustrated in FIG. 1, according to some example embodiments.

FIG. 3 is a block diagram illustrating a circuit diagram of a single-photon avalanche diode (SPAD) pixel of the pixel block illustrated in FIG. 2, according to some example embodiments.

FIG. 4 is a block diagram illustrating a configuration where the pixel block illustrated in FIG. 2 includes two detection common pixels, according to some example embodiments.

FIG. 5 is a block diagram illustrating a configuration where the pixel block illustrated in FIG. 2 includes four detection common pixels, according to some example embodiments.

FIG. 6 is a timing diagram illustrating an operation timing of an SPAD pixel, according to some example embodiments.

FIG. 7 is a block diagram illustrating a configuration of a pixel block of a solid-state imaging device, according to some example embodiments.

FIG. 8 illustrates a circuit diagram of an SPAD pixel of the pixel block illustrated in FIG. 7, according to some example embodiments.

FIG. 9 is a block diagram illustrating a configuration of a pixel block of a solid-state imaging device, according to some example embodiments.

FIG. 10 illustrates a circuit diagram of an SPAD pixel of the pixel block illustrated in FIG. 9, according to some example embodiments.

FIG. 11 illustrates a circuit diagram of a detection common pixel, according to some example embodiments.

FIG. 12 is a timing diagram illustrating an operation of detecting a variation of light incident on the detection common pixel illustrated in FIG. 11, according to some example embodiments.

FIG. 13 is a block diagram illustrating a solid-state imaging device, according to some example embodiments.

FIG. 14 is a block diagram illustrating a solid-state imaging device, according to some example embodiments.

FIG. 15 is a block diagram illustrating a solid-state imaging device, according to some example embodiments.

### DETAILED DESCRIPTION

Hereinafter, example embodiments will be described in detail with reference to the accompanying drawings. In the drawings, like reference numeral refers to like element, and a size of each element is illustrated at a ratio differing from other example embodiments, for clarity and convenience of description. Example embodiments described below are mere examples, and various modifications may be implemented from the example embodiments.

Hereinafter, being described as “on” or “over” may include being on not to contact as well as being just on to contact. It will be understood that when an element is referred to as being “on” another element, it may be directly on the other element or intervening elements may also be present. In contrast, when an element is referred to as being “directly on” another element, there are no intervening elements present. It will further be understood that when an element is referred to as being “on” another element, it may be above or beneath or adjacent (e.g., horizontally adjacent) to the other element.

A singular form of elements may include a plural form unless another case is clearly designated in context. Also, when an arbitrary portion includes or has an arbitrary element, this may denote further including another element instead of excluding another element, unless oppositely described.

Also, the use of the term “the” and the term similar thereto may correspond to all of the singular number and the plural number.

An order may be clearly described on operations configuring a method, or unless oppositely described, the operations may be performed in an appropriate order. Example embodiments of the inventive concepts are not limited to the description order of the operations. The use of all examples or terms (for example, etc.) may be merely for describing the example embodiments of the inventive concepts, and unless defined by claims, the spirit scope is not limited by the examples or the terms.

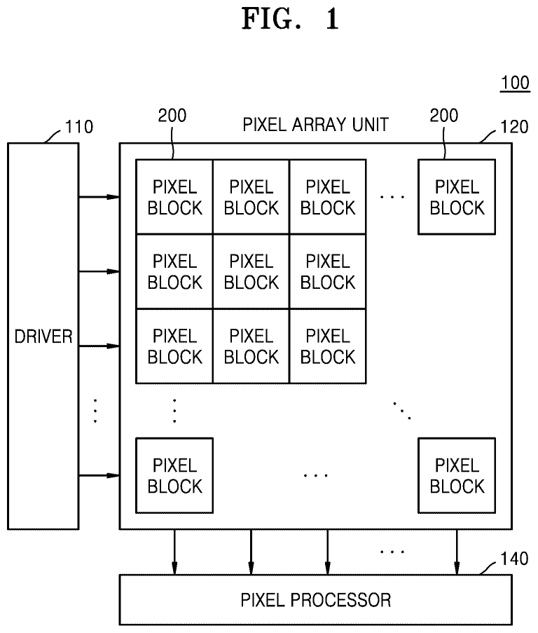

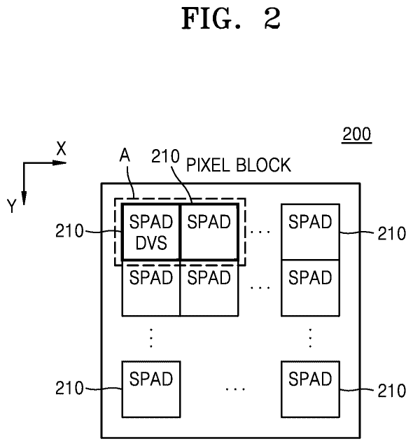

FIG. 1 is a block diagram illustrating a configuration of a solid-state imaging device 100, according to some example embodiments. FIG. 2 is a block diagram illustrating a configuration of a pixel block 200 included in a pixel array unit 120 illustrated in FIG. 1.

Referring to FIG. 1, the solid-state imaging device 100 may include a driver 110, a pixel array unit 120, and a pixel processor 140.

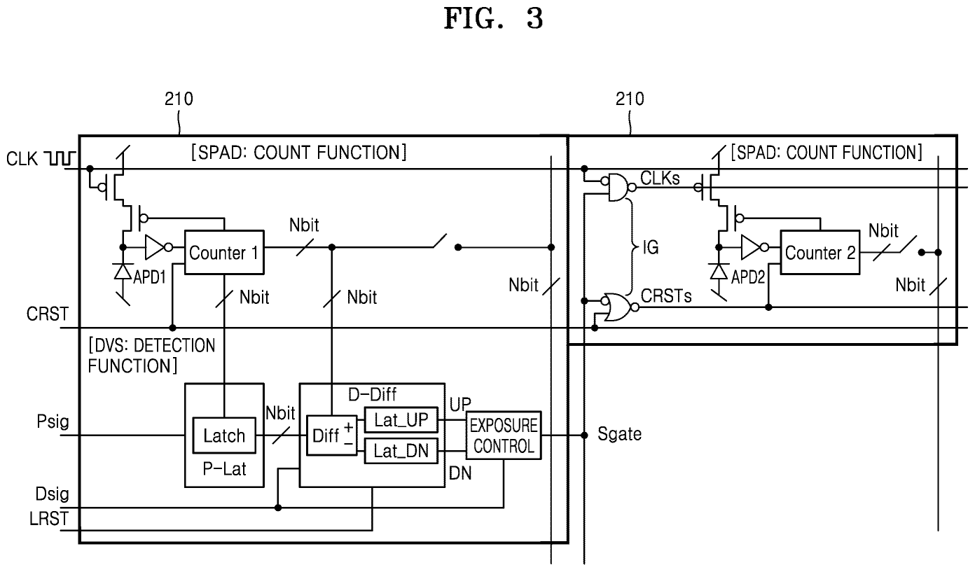

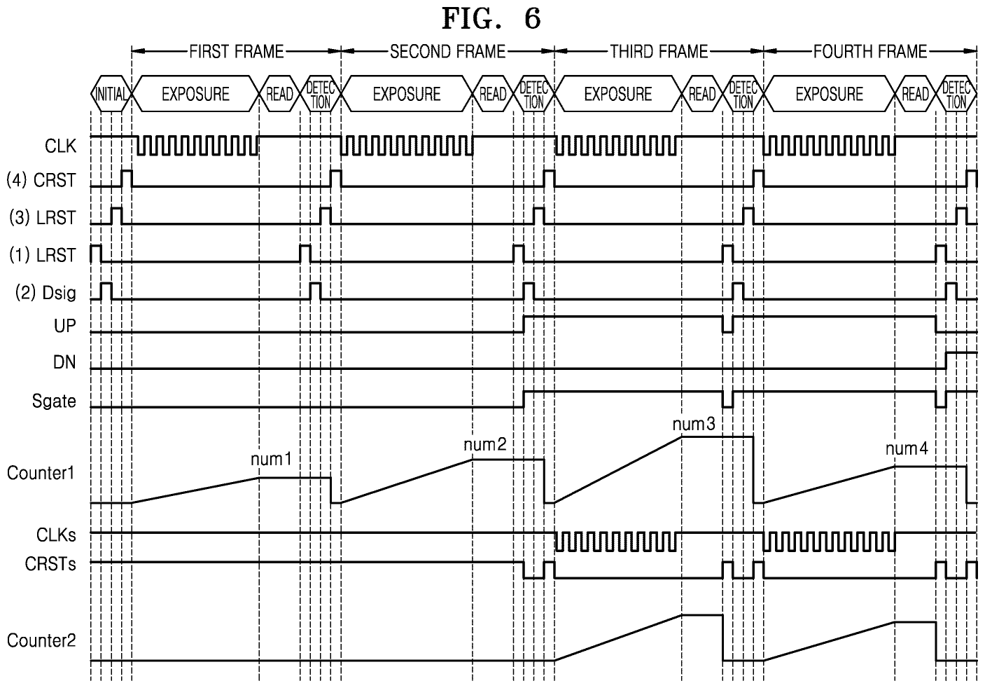

The driver 110 may input, generate or provide various signals such as a clock signal (CLK of FIG. 3), reset signals (LRST and CRST of FIG. 3), and control signals (Psig and Dsig of FIG. 3). The driver 110 may supply the various signals to the pixel array unit 120 to drive the pixel array unit 120. A timing for generating a reset signal and a control signal is described below with reference to FIG. 6.

The pixel array unit 120 may include a plurality of pixel blocks 200, which are arranged as a two-dimensional (2D) grid type (a row direction and a column direction) as seen in a plane in a vertical direction with respect to a substrate surface of the solid-state imaging device 100. Referring to FIG. 2, each of the plurality of pixel blocks 200 may include a plurality of single-photon avalanche diode (SPAD) pixels 210 arranged as a 2D grid type. Each of the pixel blocks 200 may detect a variation of incident light (hereinafter referred to as an event) and may output a detection signal. Also, each of the pixel blocks 200 may count an incident photon in a corresponding SPAD pixel 210 to output as a pixel signal.

The pixel processor 140 may execute pixel processing on a detection signal and a pixel signal received from the pixel array unit 120 to output a processing result. The pixel processing is not limited to any particular type of processing, and may include, for example, pattern recognition processing, pixel compression processing, or the like.

The pixel block 200 may include a plurality of (for example, M number of) SPAD pixels 210 for imaging. Here, M may be a natural number of 2 or more. At least one (for example, m number of) SPAD pixel of the M SPAD pixels 210 may include a detection circuit as well as a count circuit. Here, m may be a natural number of 1 or more and less than M. The count circuit may be configured for counting photons incident on the SPAD pixel 210, and the detection circuit may be configured for detecting a variation of light incident on the SPAD pixel 210.

All (M number of) SPAD pixels 210 of the M SPAD pixels 210 may include a count circuit, and the m SPAD pixels 210 may include a detection circuit. Also, (M-m) number of SPAD pixels 210 may not have a detection circuit. Herein, an SPAD pixel 210 including a count circuit and a detection circuit may be referred to as a “detection common pixel”. Referring to FIG. 2, an SPAD pixel 210, which is a detection common pixel, may be indicated by “SPAD DVS”, and an SPAD pixel 210 other than a detection common pixel may be illustrated by “SPAD”. Also, DVS may be the abbreviation for Dynamic Vision Sensor, and herein, DVS may include an additional detection circuit included in an SPAD pixel.

For example, each pixel block 200 may include 16 SPAD pixels 210 of 4 rows×4 columns. One of the 16 SPAD pixels 210 may be a detection common pixel. The detection common pixel 210 may be disposed at a certain position of the pixel block 200. In some example embodiments, when relative coordinates in orthogonal coordinates of the pixel block 200 are (x, y), a detection common pixel may be disposed at coordinates (left upper corner) of (0, 0). Here, x and y may each be an integer. A position of a detection common pixel is not limited to the left upper corner, and for example, may be assigned to be another position (for example, the center of the pixel block 200).

The number of SPAD pixels 210 included in each pixel block 200 is not limited to 16 SPAD pixels 210 arranged in 4 rows×4 columns. For example, the number of SPAD pixels 210 may be 4 that may be arranged in 2 rows×2 columns or 9 that may be arranged in 3 rows×3 columns.

A detection common pixel 210 may determine whether a variation in a property of incident light (for example, luminance, the amount of light, and/or brightness of the incident light) is greater than or equal to a certain or desired or predetermined threshold value and may thus detect an event. The certain or desired or predetermined threshold value, for example, may be a predetermined value obtained experimentally or may be a user desired value. In some example embodiments, the detection common pixel 210 may compare a measured value of the property of incident light in one previous frame with a measured value of the property of incident light in a current frame (may obtain a differential). Therefore, the detection common pixel 210 may determine whether a variation (differential) in the measured values is greater than or equal to the certain or desired or predetermined threshold value.

The detection common pixel 210 may count photons incident on the detection common pixel 210 using based on a count circuit.

Also, when a certain or desired or predetermined variation of incident light is detected by a detection circuit, the detection common pixel 210 may control driving of the SPAD pixel(s) 210 other than the detection common pixel. In some example embodiments, the detection common pixel may control the start and/or end of exposure (count incident photons) in each SPAD pixel 210. A control method for counting photons in the SPAD pixel 210 is described below with reference to FIG. 3 and FIG. 6.

FIG. 3 is a block diagram illustrating a circuit diagram of the SPAD pixel 210 of the pixel block 200 illustrated in FIG. 2. Referring to FIG. 2, M number of SPAD pixels 210 may be disposed in each pixel block 200, and m number of SPAD pixels 210 among the M SPAD pixels 210 may have detection circuit. Hereinafter, for the sake of description, the description below assumes m is one. Referring to FIG. 3, one detection common pixel and one SPAD pixel 210 adjacent to a corresponding detection common pixel are illustrated (correspond to a region A enclosed by the dashed line in FIG. 2).

Referring to FIG. 3, a count circuit of a detection common pixel may be configured or implemented by, for example, a circuit including a first counter (Counter 1) of N bits and a first avalanche photodiode (hereinafter referred to as APD1). As a reverse bias, which is greater than a breakdown voltage, is applied to a PN junction, the APD1 may operate in a Geiger mode and may output a pulse signal, based on detection of a photon. The first counter (Counter 1) may count the pulse signal from the APD1 in synchronization with a clock signal CLK.

Therefore, a photon incident on the detection common pixel may be counted. The first counter (Counter 1) may be reset by a reset signal CRST.

A detection circuit of the detection common pixel may be configured or implemented by a circuit including a first latch P-Lat, a differential circuit D-Diff, and an exposure control circuit.

The first latch P-Lat may be a latch circuit of N bits and may maintain a count value of photons counted by the first counter (Counter 1) in synchronization with a control signal Psig.

The differential circuit D-Diff may be configured or implemented by a circuit including a differentiator (D+, D−), a second latch Lat_UP, and a third latch Lat_DN. The differential circuit D-Diff may compare a count value, counted in one previous frame, and maintained in a latch in the differential module (D+, D−), with a count value in a current frame (may obtain a differential).

Also, the differential circuit D-Diff may maintain a comparison result obtained by comparing the count value of the one previous frame with the count value of the current frame. When the count value of the current frame is greater than the count value of the one previous frame and a differential between the count values is greater than the desired or predetermined threshold value, the second latch Lat_UP may put an UP signal in an active (valid or asserted) state. The second latch Lat_UP may maintain the active state of the UP signal. Also, when the count value of the one previous frame is greater than the count value of the current frame and the differential between the count values is greater than the desired or predetermined threshold value, the third latch Lat_DN may put a DN signal in an active (valid or asserted) state. The third latch Lat_DN may maintain the active state of the DN signal. The differential circuit D-Diff may be reset by the reset signal LRST.

The exposure control circuit may include an enable signal output unit. The enable signal output unit may generate an Sgate signal, based on the UP signal from the second latch Lat_UP, the DN signal from the third latch Lat_DN, and the control signal Dsig. When the UP signal and/or the DN signal are activated, the enable signal output unit may activate the Sgate signal in synchronization with the control signal Dsig.

Also, the exposure control circuit may further include an exposure timer. The exposure timer may count a time corresponding to an exposure period from the start of each frame. The exposure period may be a desired or predetermined value. The exposure timer may generate an exposure control signal which is activated or asserted until a time corresponding to the exposure period from the start of each frame elapses.

A count circuit of the SPAD pixel 210 may be configured or implemented by, for example, a circuit including an input gate (a gate unit) IG, a second avalanche photodiode APD2, and a second counter (Counter 2) of N bits. As a reverse bias, which is greater than a breakdown voltage, is applied to a PN junction, the second avalanche photodiode APD2 may operate in the Geiger mode and may output a pulse signal, based on detection of a photon. The second counter (Counter 2) may count the pulse signal from the second avalanche photodiode APD2 in synchronization with a clock signal CLKs. Therefore, a photon incident on the SPAD pixel 210 may be counted. Also, the second counter (Counter 2) may be reset by a reset signal CRSTs. The clock signal CLKs and the reset signal CRSTs may be generated by a detection circuit of the detection common pixel and may be activated by the Sgate signal input to the input gate IG. Stated otherwise, the second counter (Counter 2) may be enabled by the Sgate signal.

The above discussion of the count circuit of one SPAD pixel 210 adjacent to the detection common pixel is equally applicable to count circuits of other SPAD pixel(s) 210 of the pixel block 200, and thus, a discussion thereof is not repeated for the sake of brevity.

The above discussion is directed to the pixel block 200 including one detection common pixel (m is 1), and the discussion is equally applicable to a pixel block 200 including a plurality of detection common pixels (m is 2 or more) and is not repeated herein for the sake of brevity.

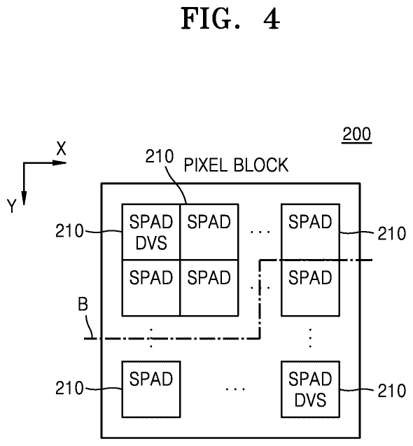

FIG. 4 is a block diagram illustrating a configuration where the pixel block 200 illustrated in FIG. 2 includes two detection common pixels, according to some example embodiments. In the pixel block 200, in addition to a first detection common pixel at relative coordinates (0, 0), a second detection common pixel may be disposed at coordinates (xmax, ymax). Here, xmax and ymax may be maximum values of x, y coordinates in the pixel block 200, respectively. For example, a target of an SPAD pixel 210, which controls exposure by using the first detection common pixel, may be configured to be an up range where the pixel block 200 is divided into two along a dash-single dotted line B illustrated in FIG. 4. Also, for example, a target of an SPAD pixel 210, which controls exposure by using the second detection common pixel, may be configured to be a down range where the pixel block 200 is divided into two.

As described above, because the pixel block 200 includes a plurality of detection common pixels, a position of a detection common pixel may be close to or adjacent a position of an SPAD pixel 210 of an exposure control target in the pixel block 200. Therefore, the precision of an event on an SPAD pixel 210 of an exposure control target based on a detection common pixel may be enhanced, improved, or maximized. Also, a detection common pixel may be disposed at the center portion of the pixel block 200 within each target range, and thus, may be closer to an SPAD pixel 210 of an exposure control target.

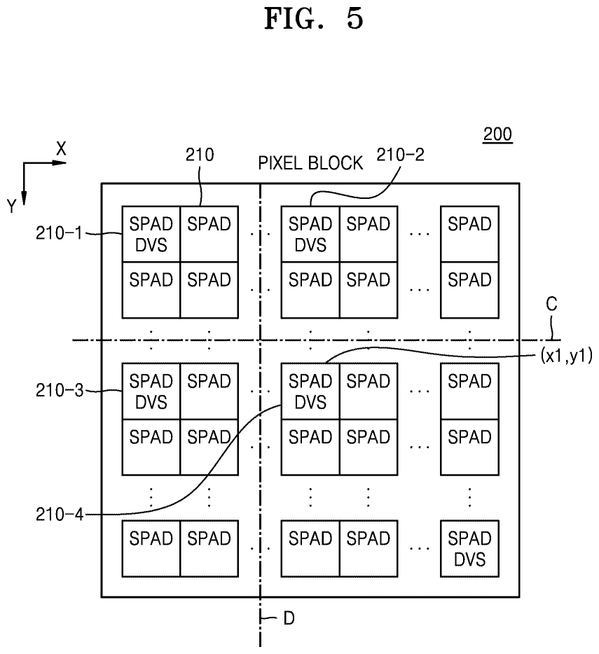

FIG. 5 is a block diagram illustrating a configuration where the pixel block 200 illustrated in FIG. 2 includes four detection common pixels (210-1, 210-2, 210-3, 210-4, collectively, detection common pixels 210), according to some example embodiments. In a pixel block 200, in addition to a first detection common pixel 210-1 at relative coordinates (0, 0), a second detection common pixel may be disposed at coordinates (xmax, ymax). Here, xmax and ymax may be maximum values of x, y coordinates in the pixel block 200, respectively. For example, a target of an SPAD pixel 210, which controls exposure by using the first detection common pixel 210-1, may be configured to be an up range where the pixel block 200 is divided into two along a dash-single dotted line C illustrated in FIG. 5. Also, for example, a target of an SPAD pixel 210, which controls exposure by using the second detection common pixel 210-2, may be configured to be a down range where the pixel block 200 is divided into two. Also, a target of an SPAD pixel 210, which controls exposure by using the third detection common pixel 210-3, may be configured to be a left down range where the pixel block 200 is divided into two along a dash-single dotted line D. Also, a target of an SPAD pixel 210, which controls exposure by using the fourth detection common pixel 210-4, may be configured to be a right down range where the pixel block 200 is divided into two along a dash-single dotted line B. Also, like the embodiment of FIG. 4, a detection common pixel may be disposed at the center portion (e.g., at relative coordinates (x1, y1)) of the pixel block 200 within each target range, and thus, may be closer to an SPAD pixel 210 of an exposure control target.

As described above, as the number of detection common pixels increases in the pixel block 200, a position of a detection common pixel may be closer or adjacent to a position of an SPAD pixel 210 of an exposure control target in the pixel block 200. Therefore, the precision of an event on an SPAD pixel 210 of an exposure control target based on a detection common pixel may be more enhanced or improved or maximized.

FIG. 6 is a timing diagram illustrating an operation timing of an SPAD pixel, according to some example embodiments. Referring to FIG. 6, an operation timing in first to fourth frames is shown. An initial time may be executed, and then, the first to fourth frames may be executed in order. Each of the first to fourth frames may be divided into an exposure period, a read period, and a detection period.

First, in the initial period, the driver 110 may synchronize (1) a reset signal LRST, (2) a control signal Dsig, (3) a control signal Psig, and (4) a reset signal CRST with a clock signal CLK in order to output as a pulse signal. The second latch Lat_UP and the third latch Lat_DN of the detection common pixel may be reset by the reset signal LRST. Also, a first counter Counter1 may be reset by the reset signal CRST. The first latch P-Lat may maintain an initial value “0” of the first counter Counter1, based on the control signal Psig.

Subsequently, in the exposure period of the first frame succeeding the initial period, the detection common pixel may count photons incident on the detection common pixel in synchronization with the clock signal CLK, based on the first counter Counter1. The first counter Counter1 may output a count value. The driver 110 may supply the detection common pixel with the clock signal CLK having a predetermined number of pulses corresponding to the exposure period. Therefore, the first counter Counter1 may count photons in the exposure period. Furthermore, because an Sgate signal is deactivated, a clock signal CLKs and a reset signal CRSTs of another SPAD pixel 210 included in the pixel block 200 may not be valid, and the second counter Counter2 may not count photons incident on the SPAD pixel 210.

Subsequently, in the read period succeeding the exposure period, the first counter Counter1 may read a designated count value num1.

Subsequently, in the detection period succeeding the read period, the driver 110 may synchronize (1) the reset signal LRST, (2) the control signal Dsig, (3) the control signal Psig, and (4) the reset signal CRST with the clock signal CLK in order to output as a pulse signal. The second latch Lat_UP and the third latch Lat_DN of the detection common pixel may be reset by the reset signal LRST. Subsequently, the differential circuit D-Diff may compare a count value of one previous frame with a count value of a current frame in synchronization with the control signal Dsig to maintain a latch state of each of the second latch Lat_UP and the third latch Lat_DN. The first latch P-Lat may maintain the count value num1 of the first counter Counter1, based on the control signal Psig subsequent thereto, but at a comparison time based on the differential circuit D-Diff, the first latch P-Lat may maintain a certain value or an initial value “O” of the first counter Counter1. In the embodiment of FIG. 6, the certain value other than 0 may be maintained to be the initial value. As a result of the comparison by the differential circuit D-Diff, when a first count value num1 does not satisfy a certain threshold value, an UP signal and a DN signal may be deactivated, and the Sgate signal may also be deactivated. Subsequently, the first latch P-Lat may maintain the first count value num1 of the first counter Counter1, based on the control signal Psig. Also, a first counter Counter1 may be reset by the reset signal CRST. Furthermore, in a case where the initial value is 0, when the Sgate signal is activated in the detection period of the first frame, another SPAD pixel 210 (the clock signal CLKs and the reset signal CRSTs) included in the pixel block 200 may be driven from the second frame.

Subsequently, in the exposure period of the second frame, the detection common pixel may count photons incident on the detection common pixel in synchronization with the clock signal CLK, based on the first counter Counter1. The first counter Counter1 may output a count value. The driver 110 may supply the detection common pixel with the clock signal CLK having a predetermined number of pulses corresponding to the exposure period. Therefore, the first counter Counter1 may count photons in the exposure period. Furthermore, because an Sgate signal is deactivated, a clock signal CLKs and a reset signal CRSTs of another SPAD pixel 210 included in the pixel block 200 may not be valid, and the second counter Counter2 may not count photons incident on the SPAD pixel 210.

Subsequently, in the read period succeeding the exposure period, the first counter Counter1 may read a designated second count value num2.

Subsequently, in the detection period succeeding the read period, the driver 110 may synchronize (1) the reset signal LRST, (2) the control signal Dsig, (3) the control signal Psig, and (4) the reset signal CRST with the clock signal CLK in order to output as a pulse signal. The second latch Lat_UP and the third latch Lat_DN of the detection common pixel may be reset by the reset signal LRST. Subsequently, the differential circuit D-Diff may compare a count value of one previous frame with a count value of a current frame in synchronization with the control signal Dsig to maintain a latch state of each of the second latch Lat_UP and the third latch Lat_DN. Here, the first latch P-Lat may maintain the second count value num2 of the first counter Counter1, based on the control signal Psig subsequent thereto, but at a comparison time based on the differential circuit D-Diff, the first latch P-Lat may maintain the first count value num1 in one previous frame. Here, the first count value num1 may be assumed to be a value which is less than the second count value num2. As in the embodiment of FIG. 6, when “second count value−first count value” (num2−num1) is greater than or equal to the certain or desired or predetermined threshold value, as a result of the comparison by the differential circuit D-Diff, the UP signal may be activated, and thus, the Sgate signal may also be activated. Subsequently, the first latch P-Lat may maintain the second count value num2 of the second counter Counter1, based on the control signal Psig. Also, the first counter Counter1 may be reset by the reset signal CRST.

Subsequently, in the exposure period of the third frame, the detection common pixel may count photons incident on the detection common pixel in synchronization with the clock signal CLK, based on the first counter Counter1. The first counter Counter1 may output a count value. The driver 110 may supply the detection common pixel with the clock signal CLK having a predetermined number of pulses corresponding to the exposure period. Therefore, the first counter Counter1 may count photons in the exposure period. As a result of comparison in the second frame, because the Sgate signal is activated, the clock signal CLKs and the reset signal CRSTs of another SPAD pixel 210 included in the pixel block 200 may be valid, and the SPAD pixel 210 may count photons incident on the SPAD pixel 210 in synchronization with the clock signal CLKs, based on the second counter Counter2. The second counter Counter2 may output a count value.

Subsequently, in the read period succeeding the exposure period, the first counter Counter1 may read a designated third count value num3.

Subsequently, in the detection period succeeding the read period, the driver 110 may synchronize (1) the reset signal LRST, (2) the control signal Dsig, (3) the control signal Psig, and (4) the reset signal CRST with the clock signal CLK in order to output as a pulse signal. The second latch Lat_UP and the third latch Lat_DN of the detection common pixel may be reset by the reset signal LRST. Subsequently, the differential circuit D-Diff may compare a count value of one previous frame with a count value of a current frame in synchronization with the control signal Dsig to maintain a latch state of each of the second latch Lat_UP and the third latch Lat_DN. The first latch P-Lat may maintain the third count value num3 of the first counter Counter1, based on the control signal Psig subsequent thereto, but at a comparison time based on the differential circuit D-Diff, the first latch P-Lat may maintain the first count value num1 in one previous frame. The first count value num1 may be assumed to be a value which is less than the second count value num2. As in the embodiment of FIG. 6, when “third count value−second count value” (num3−num2) is greater than or equal to the certain or desired or predetermined threshold value, as a result of the comparison by the differential circuit D-Diff, the UP signal may be activated, and thus, the Sgate signal may also be activated. Subsequently, the first latch P-Lat may maintain the second count value num2 of the second counter Counter1, based on the control signal Psig. Also, the first counter Counter1 may be reset by the reset signal CRST.

Subsequently, in the exposure period of the fourth frame, the detection common pixel may count photons incident on the detection common pixel in synchronization with the clock signal CLK, based on the first counter Counter1. The first counter Counter1 may output a count value. The driver 110 may supply the detection common pixel with the clock signal CLK having a predetermined number of pulses corresponding to the exposure period. Therefore, the first counter Counter1 may count photons in the exposure period. As a result of comparison in the third frame, because the Sgate signal is activated, the clock signal CLKs and the reset signal CRSTs included in the pixel block 200 may be valid, and the SPAD pixel 210 may count photons incident on the SPAD pixel 210 in synchronization with the clock signal CLKs, based on the second counter Counter2. The second counter Counter2 may output a count value.

Subsequently, in the read period succeeding the exposure period, the first counter Counter1 may read a designated fourth count value num4.

Subsequently, in the detection period succeeding the read period, the driver 110 may synchronize (1) the reset signal LRST, (2) the control signal Dsig, (3) the control signal Psig, and (4) the reset signal CRST with the clock signal CLK in order to output as a pulse signal. The second latch Lat_UP and the third latch Lat_DN of the detection common pixel may be reset by the reset signal LRST. Subsequently, the differential circuit D-Diff may compare a count value of one previous frame with a count value of a current frame in synchronization with the control signal Dsig to maintain a latch state of each of the second latch Lat_UP and the third latch Lat_DN. The first latch P-Lat may maintain the fourth count value num4 of the first counter Counter1, based on the control signal Psig subsequent thereto, but at a comparison time based on the differential circuit D-Diff, the first latch P-Lat may maintain the third count value num3 in one previous frame. The third count value num3 may be assumed to be a value which is less than the fourth count value num4. As in the embodiment of FIG. 6, when “third count value−fourth count value” (num3−num4) is greater than or equal to the certain threshold value, as a result of the comparison by the differential circuit D-Diff, the DN signal may be activated, and thus, the Sgate signal may also be activated. Subsequently, the first latch P-Lat may maintain the fourth count value num4 of the second counter Counter1, based on the control signal Psig. Also, a first counter Counter1 may be reset by the reset signal CRST.

As described above, a series of operations compare a count value of a previous frame with a count value of a current frame in a detection common pixel to determine whether to drive an SPAD pixel 210 of a next frame.

In the SPAD pixel 210, according to some example embodiments, a count circuit and a detection circuit may be configured or implemented using a logic circuit, and, as a result of miniaturization of semiconductor devices, an area occupied by the logic circuits may be relatively smaller. A logic circuit implementing a count circuit and a logic circuit implementing a detection circuit may be disposed on a single wafer, or may be disposed on different wafers. For example, a first logic circuit for a count circuit and a second logic circuit for a detection circuit may be stacked and formed on a wafer where the first logic circuit is formed. The solid-state imaging device 100 may include a first wafer where a count circuit is provided and a second wafer where a detection circuit is provided, and which is stacked on the first wafer.

The solid-state imaging device 100, according to some example embodiments described above may realize the following effect.

At least one SPAD pixel 210 of the pixel block 200 may have a detection circuit of detecting a variation of light incident on a corresponding SPAD pixel 210. That is, at least one SPAD pixel 210 of the pixel block 200 may have a count circuit and a detection circuit. Therefore, all SPAD pixels 210 of the pixel block 200 may be configured to have a count circuit without adding a detection circuit thereto. Accordingly, the solid-state imaging device 100 may prevent or reduce or minimize a reduction in spatial resolving power in imaging and may prevent or reduce or minimize an increase in the number of processes and complexity in developing of the solid-state imaging device.

Also, at least one SPAD pixel 210 may have a count circuit and a detection circuit, and thus, because it is not required to add a detection circuit thereto, an increase in area of the solid-state imaging device 100 may be prevented or reduce or minimize.

Also, because at least one SPAD pixel 210 has a count circuit and a detection circuit, power for driving the pixel block 200 may be reduced or minimized.

Also, because a count circuit and a detection circuit are implemented by a logic circuit, an area may decrease as a result of miniaturization.

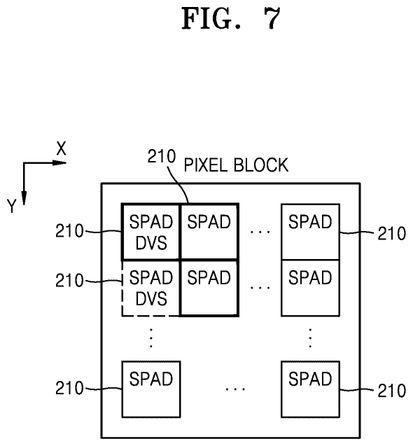

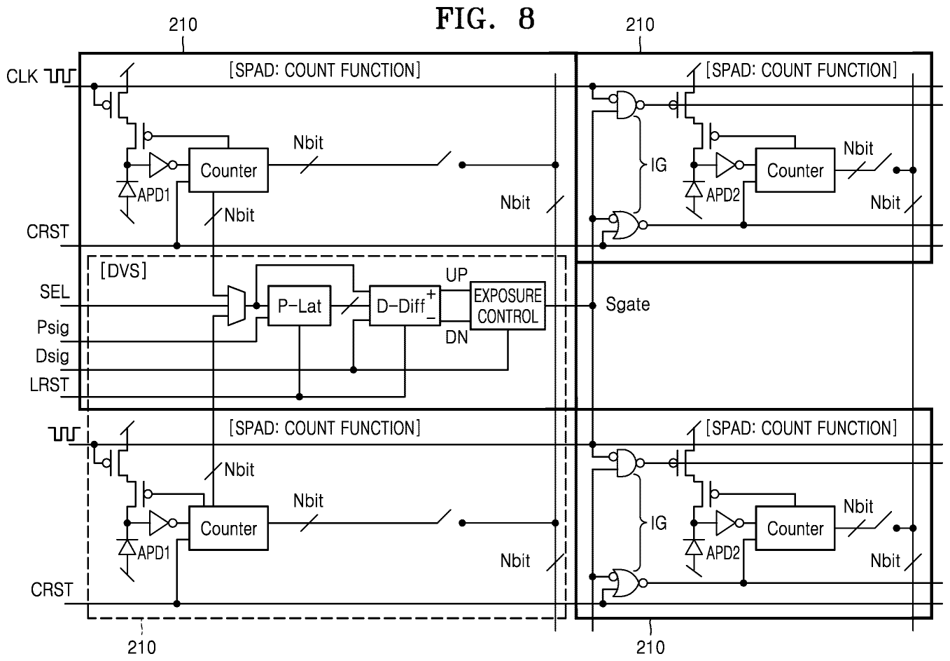

According to some example embodiments, FIGS. 1 to 6 discuss the pixel block 200 including one detection common pixel or a plurality of independent detection common pixels. The discussion of FIGS. 7 and 8 is directed to a pixel block 200 that includes a plurality of detection common pixels and the plurality of detection common pixels share a detection circuit.

FIG. 7 is a block diagram illustrating a configuration of a pixel block of a solid-state imaging device, according to some example embodiments. FIG. 8 illustrates a circuit diagram of an SPAD pixel of the pixel block illustrated in FIG. 7. The solid-state imaging device in FIGS. 7 and 8 may be similar in some respects to the solid-state imaging device of FIGS. 1-6, and therefore may be best understood with reference thereto where like numerals indicate like elements not described again in detail.

Referring to FIG. 7, at least two (for example, p number of) SPAD pixels of M number of SPAD pixels of a pixel block 200 may have a detection circuit as well as a count circuit. Here, p may be a natural number of 2 or more and less than M.

All the M SPAD pixels 210 may include a count circuit. The p SPAD pixels 210 may include a detection circuit, but (M−p) number of SPAD pixels 210 may not include a detection circuit.

For example, each pixel block 200 may include 16 SPAD pixels 210 arranged in 4 rows×4 columns. Two of the 16 SPAD pixels 210 may be a first detection common pixel and a second detection common pixel. The first detection common pixel may be disposed at a position of coordinates (0, 0) in orthogonal coordinates, and the second detection common pixel may be disposed at a position of coordinates (0, 1) adjacent to the first detection common pixel (enclosed with a dashed line in FIG. 8). The first and second detection common pixels are not limited to an adjacent position relationship and may be disposed at positions apart from each other.

According to some example embodiments, the first detection common pixel and the second detection common pixel may share a detection circuit DVS. A detection circuit may include a selector which selects a count value which is to be used and is based on a counter of one of the first detection common pixel and the second detection common pixel. The count value selected by the selector may be maintained or latched in a first latch P-Lat, based on a control signal Psig. Descriptions and/or operations of a differential circuit D-Diff and an exposure control circuit may be the same as the descriptions of FIGS. 1 to 6, and thus, are omitted herein for sake of brevity. Also, referring to FIG. 8, descriptions of the second latch Lat_UP and the third latch Lat_DN are omitted. Operations of a second latch Lat_UP and a third latch Lat_DN may be the same as the operations of the second latch Lat_UP and the third latch Lat_DN illustrated in FIGS. 1 to 6.

Example embodiments in FIGS. 7 and 8 are directed to a solid-state imaging device having two detection common pixels (p is 2); however, example embodiments are not limited thereto and are equally applicable to configurations including three or more detection common pixels (p is 3 or more). For example, in a configuration including three detection common pixels, the three detection common pixels may share a detection circuit.

The solid-state imaging device 100 according to some example embodiments described above may realize the following technical effects in addition to the technical effects of FIGS. 1 to 6.

A detection circuit of one of a plurality of detection common pixels may be appropriately selected. Because a plurality of detection common pixels share a detection circuit, an increase in area of the solid-state imaging device 100 may be prevented, reduced or minimized, and an event may be detected at different positions of the pixel block 200, thereby improving and/or maximizing the precision of event detection.

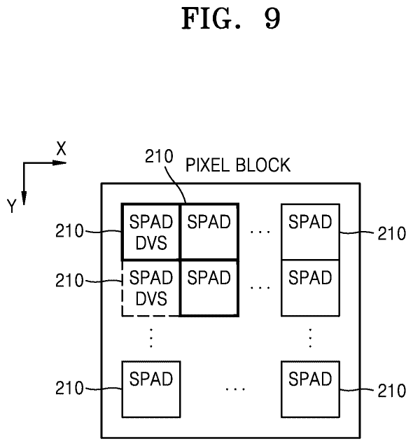

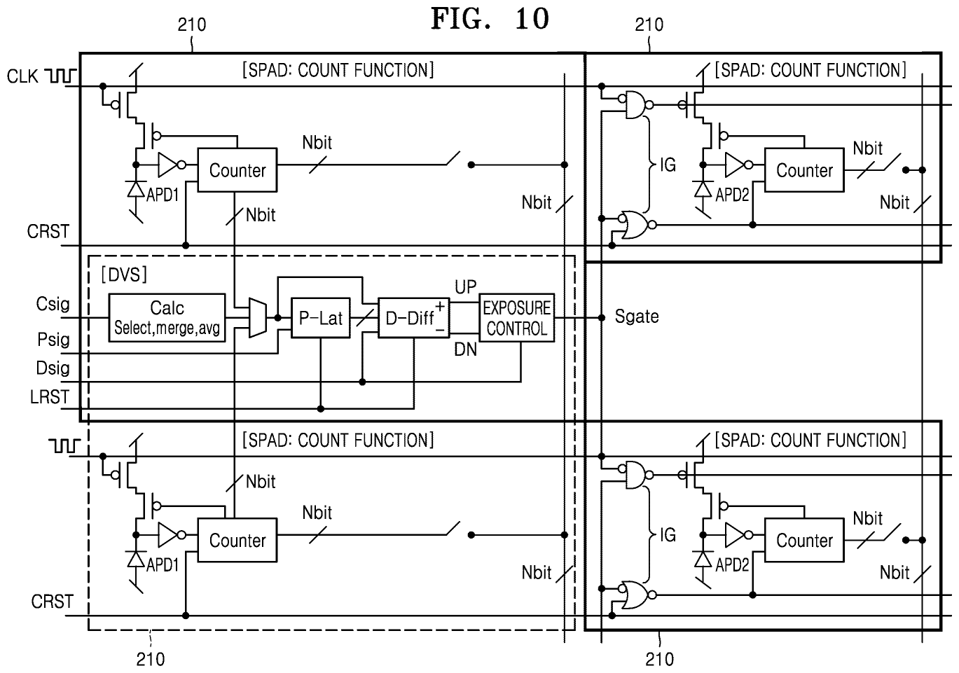

According to some example embodiments, FIGS. 7 and 8 discuss the pixel block 200 including a plurality of detection common pixels and the plurality of detection common pixels sharing a detection circuit. The discussion of FIGS. 9 and 10 is directed to a configuration where a plurality of detection common pixels share a detection circuit, and an event may be detected based on a count value from the detection circuit of each of the plurality of detection common pixels.

FIG. 9 is a block diagram illustrating a configuration of a pixel block of a solid-state imaging device, according to some example embodiments. FIG. 10 illustrates a circuit diagram of an SPAD pixel of the pixel block illustrated in FIG. 9. The solid-state imaging device in FIGS. 9 and 10 may be similar in some respects to the solid-state imaging devices of FIGS. 1-8, and therefore may be best understood with reference thereto where like numerals indicate like elements not described again in detail.

According to some example embodiments, a first detection common pixel and a second detection common pixel may share a detection circuit DVS. A detection circuit may generate a count value based on a counter of each of the first detection common pixel and the second detection common pixel to perform a certain, predetermined, or desired arithmetic operation, based on a control signal Csig, and may output an obtained value to a first latch P-Lat. The certain, predetermined, or desired arithmetic operation, for example, may be a mergence (union, or addition) or an average of the count values based on the counters of the first detection common pixel and the second detection common pixel. The count value selected by a selector may be maintained or latched in the first latch P-Lat, based on a control signal Psig. Descriptions and/or operations a differential circuit D-Diff and an exposure control circuit may be the same as those of FIGS. 1 to 6, and thus, are omitted herein for the sake of brevity. Also, referring to FIG. 9, descriptions of a second latch Lat_UP and a third latch Lat_DN are omitted for the sake of brevity. Operations of the second latch Lat_UP and the third latch Lat_DN may be the same as the operations of the second latch Lat_UP and the third latch Lat_DN described above with reference to FIGS. 1 to 6, and are not described again in detail for the sake of brevity.

Example embodiments in FIGS. 9 and 10 are directed to a solid-state imaging device having two detection common pixels (p is 2); however, example embodiments are not limited thereto and are equally applicable to configurations including three or more detection common pixels (p is 3 or more). For example, in a configuration including three detection common pixels, an event may be detected based on a count value of a detection circuit of each of the three detection common pixels.

According to some example embodiments described above, the solid-state imaging device 100 may realize the following effects in addition to the effects of FIGS. 1 to 8.

Because an event may be detected based on a count value of a detection circuit of each of the three detection common pixels, the event may be detected with improved precision.

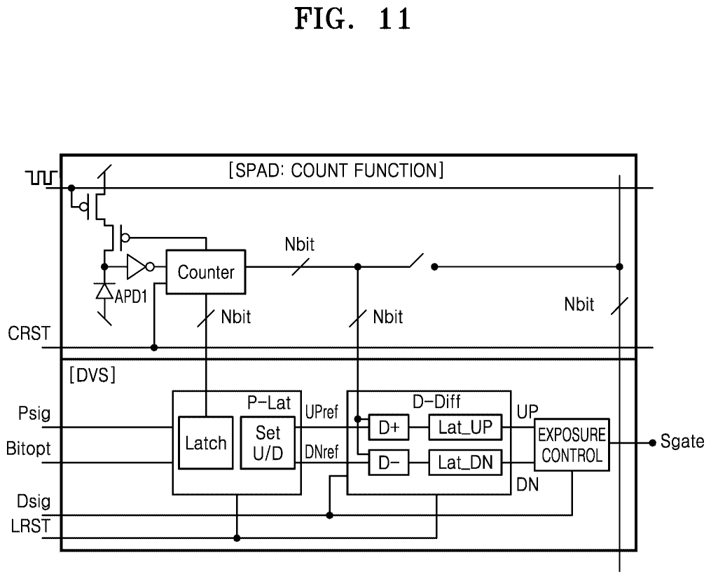

According to some example embodiments, the discussion in FIGS. 11 to 14 may be directed to examples where an offset is set on a count value of a photon in one previous frame. According to some example embodiments of FIGS. 11 to 14, exposure may be controlled based on a comparison result of a count value of a current frame and a count value obtained by adding a predetermined or desired offset value to a count value of a photon in one previous frame.

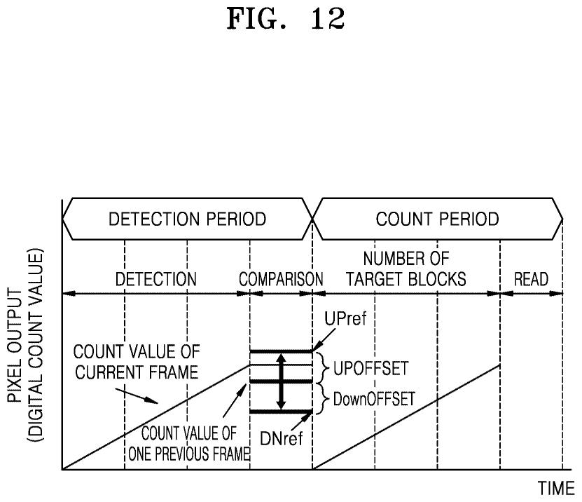

FIG. 11 illustrates a circuit diagram of a detection common pixel, according to some example embodiments. FIG. 12 is a timing diagram illustrating an operation of detecting a variation of light incident on the detection common pixel illustrated in FIG. 11, according to some example embodiments. The discussion with reference to FIGS. 9 and 10 may be similar in some respects to the discussion with reference to FIGS. 1-6, and therefore may be best understood with reference thereto where like numerals indicate like elements not described again in detail.

Referring to FIG. 11, a detection circuit of a detection common pixel, according to some example embodiments, may be configured or implemented by a circuit including a first latch P-Lat, a differential circuit D-Diff, and an exposure control circuit.

The first latch P-Lat may be configured or implemented by a circuit including a latch circuit Latch and an offset setting unit SetU/D. The latch circuit Latch may maintain or latch a count value of a photon counted by a counter of a count circuit in synchronization with a control signal Psig. Also, the offset setting unit may set an UP offset value and a DOWN offset value, based on bit shift on a count value maintained or latched in one previous frame. The UP offset value and the DOWN offset value may respectively correspond to an upper limit and a lower limit of a range of a width of a count value of one previous frame.

The offset setting unit SetU/D may be configured to set an offset in p operation (where p may be a natural number), based on bit shift. Also, the offset setting unit SetU/D may be configured to set the UP offset value and the DOWN offset value to a plurality of operations. Also, the offset setting unit SetU/D may be configured to maintain the UP offset value and the DOWN offset value. Also, the offset setting unit SetU/D may be configured to dynamically vary a setting range of the UP offset value and the DOWN offset value. Also, the offset setting unit SetU/D may be configured to set the UP offset value and the DOWN offset value to N bits having a variable width. As described above, count values obtained by adding a certain, desired, or predetermined offset value to a count value of a photon in one previous frame may be an UP reference count value UP_ref and a DOWN reference count value DN_ref, respectively.

The differential circuit D-Diff may be configured or implemented by a circuit including a differentiator (D+, D−), a second latch Lat_UP, and a third latch Lat_DN. The differential circuit D-Diff may compare the UP reference count value UP_ref with a count value of a current frame counted by a counter in a differentiator (may obtain a differential). The differential circuit D-Diff may compare the DOWN reference count value DN_ref with the count value of the current frame counted by a first counter (Counter 1) in the differentiator (may obtain a differential value).

When the count value of the current frame is greater than the UP reference count value UP_ref, the second latch Lat_UP may put an UP signal in an active (valid) state. The second latch Lat_UP may maintain or latch the active state of the UP signal. Also, when the count value of the current frame is greater than the DOWN reference count value DN_ref, the third latch Lat_DN may put a DN signal in an active (valid) state. The third latch Lat_DN may maintain or latch the active state of the DN signal. Otherwise, the UP signal and the DN signal may be put in an inactive state. Therefore, an insensitive region where an event is not detected between the UP offset value and the DOWN offset value may be generated, and a sensitivity of event occurrence may be adjusted.

Referring to FIG. 12, a detection common pixel may count a photon incident on the detection common pixel by using a counter in a detection period, based on a count circuit. Also, the detection common pixel may set an UP reference count value and a DOWN reference count value, based on a count value maintained in one previous frame. Also, the detection common pixel may compare the UP/DOWN reference count value with a count value of a current frame. Also, the detection common pixel may generate an UP signal/DN signal in a count period, based on a comparison result. In some example embodiments, the differential circuit D-Diff may maintain or latch a comparison result (a differential) between a count value of one previous frame and a count value of a current frame and may compare the differential with the UP offset value or the DOWN offset value, and thus, may perform control so that an Sgate signal is activated or deactivated.

Furthermore, referring to FIG. 12, a detection period and a count period may be set to the same time, however, in some other example embodiments, the detection period and the count period may be at different times.

Also, the offset setting unit SetU/D may be configured to adjust (control) the UP offset value or the DOWN offset value, based on the UP signal/DN signal. For example, when the UP signal is activated, the offset setting unit SetU/D may be configured so that the UP offset value increases. Also, when the DOWN signal is activated, the offset setting unit SetU/D may be configured so that the DOWN offset value is an absolute value and decreases.

An exposure timer of the exposure control circuit may be configured to adjust an exposure period, instead of adjusting the UP offset value and the DOWN offset value. The detection common pixel may be configured to control the start and end of photon counting by using a counter, based on the UP signal/DN signal. For example, when the UP signal is activated or asserted, the detection common pixel may adjust a setting value of an exposure period of the exposure timer so that the exposure period is reduced. Also, for example, when the DOWN signal is activated or asserted, the detection common pixel may adjust the setting value of the exposure period of the exposure timer so that the exposure period increases.

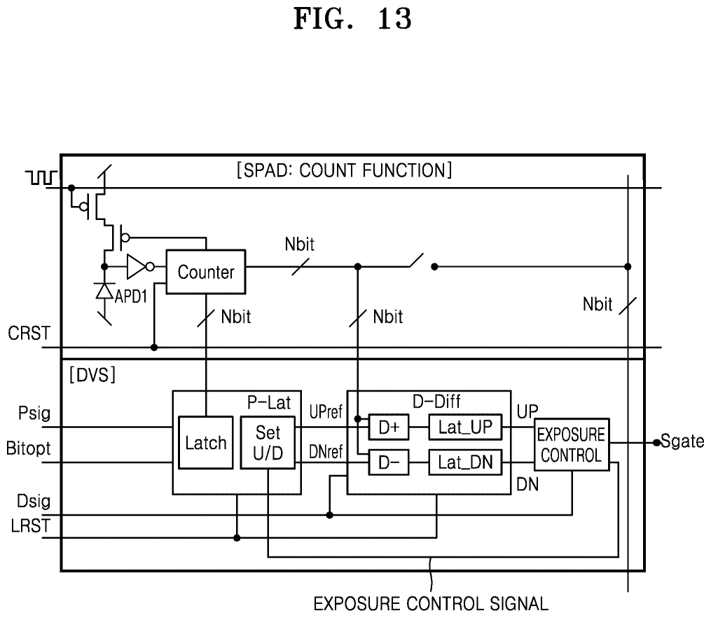

FIG. 13 is a block diagram illustrating a solid-state imaging device, according to some example embodiments. In some example embodiments, an exposure control circuit may generate an exposure control signal for controlling an offset setting unit SetU/D, based on an UP signal/DN signal. The offset setting unit SetU/D may vary (adjust) an UP offset value and a DOWN offset value, based on the exposure control signal. The exposure timer may change the exposure control signal, based on the UP signal and/or the DN signal. For example, when the UP signal is activated or asserted, the exposure timer may change the exposure control signal so that the exposure period is reduced. Also, for example, when the DOWN signal is activated or asserted, the exposure timer may change the exposure control signal so that the exposure period increases.

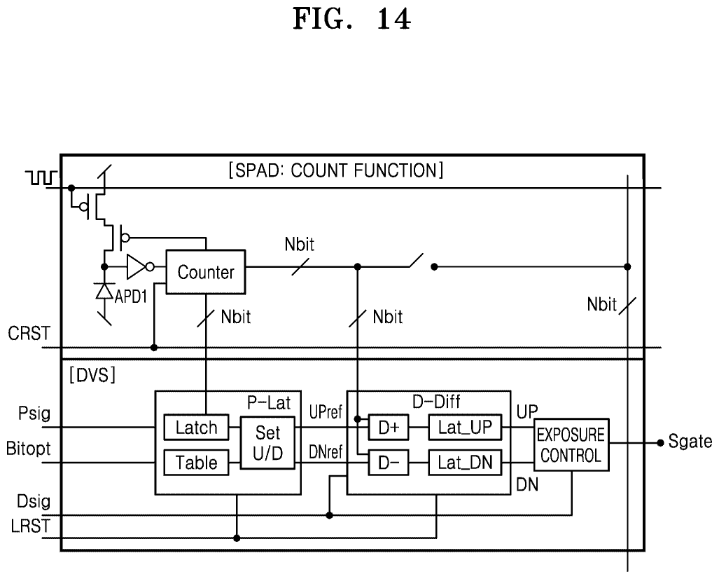

FIG. 14 is a block diagram illustrating a solid-state imaging device, according to some example embodiments. In some example embodiments, a first latch P-Lat may be configured or implemented by a circuit including a latch circuit Latch, an offset setting unit SetU/D, and a lookup table (LUT) unit.

A count value of a photon counted by a counter in one previous frame may be maintained or latched in the latch circuit Latch. Also, the LUT unit may be a table which provides an UP offset value and a DOWN offset value on the count value maintained in the latch circuit Latch. Therefore, the UP offset value and the DOWN offset value each based on the amount of measured light in one previous frame may be reflected in the offset setting unit SetU/D.

In addition to the technical effects provided by the solid-state imaging device of FIGS. 1-10, or in alternative thereto, the solid-state imaging device 100, according to some example embodiments, may provide the technical effect of adjusting or improving a sensitivity of event occurrence in an insensitive region where an event may not be detected between the UP offset value and the DOWN offset value.

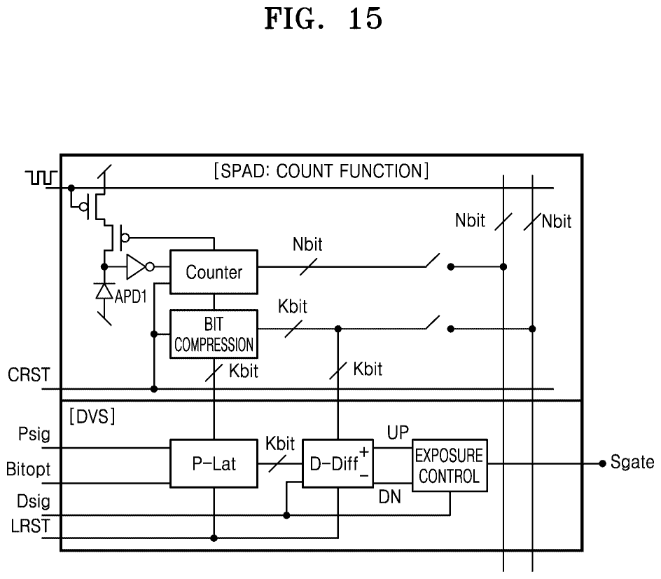

According to some example embodiments, FIG. 15 may be directed to examples where a count circuit reduces a count value of an N-bit counter to K (K<N) bits and a detection circuit compares the count value with K bits.

FIG. 15 is a block diagram illustrating a solid-state imaging device, according to some example embodiments. The discussion with reference to FIG. 15 may be similar in some respects to the discussion with reference to FIGS. 1-6, and therefore may be best understood with reference thereto where like numerals indicate like elements not described again in detail.

According to some example embodiments, a detection circuit may include a bit compression unit as well as a first avalanche photodiode APD1 and a counter. Operations of the first avalanche photodiode APD1 and the counter may be the same as the operations of the first avalanche photodiode APD1 and the counter described above with reference to FIGS. 1 to 6, and are omitted herein for the sake of brevity. The bit compression unit may reduce a count value of an N-bit counter to K (K<N) bits. The bit compression unit, for example, may be configured to output upper K bits of input N-bit data.

A detection circuit of the detection common pixel may be configured or implemented using a circuit including a first latch P-lat, a differential circuit D-Diff, and an exposure control circuit.

The first latch P-Lat may be a latch circuit of K bits and may maintain a count value of photons counted by a counter of the detection circuit in synchronization with a control signal Psig.

A differential circuit D-Diff may compare a count value (K bits), which is counted by a first counter (Counter 1) in one previous frame in a differentiator and is maintained or latched in a latch, with a count value (K bits) of a current frame counted by the first counter (Counter 1) in a differentiator (may obtain a differential value). An operation of an exposure control circuit may as discussed above with reference to FIGS. 1 to 6, and, a detailed description thereof is omitted herein. Also, referring to FIG. 15, descriptions of a second latch Lat_UP and a third latch Lat_DN are similar to the descriptions above and are omitted. Operations and/or circuits of the second latch Lat_UP and the third latch Lat_DN may be the same as the operations and/or circuits of the second latch Lat_UP and the third latch Lat_DN described above with reference to FIGS. 1 to 6, and may be best understood by reference thereto, and are omitted herein for the sake of brevity.

In addition to the technical effects provided by the solid-state imaging device of FIGS. 1-6 or in alternative thereto, the solid-state imaging device 100, according to some example embodiments described above, decrease a chip area of the pixel array unit 120 because the detection circuit compares a count value with K bits (reduced number of buts) may decrease.

As described herein, any devices, systems, blocks, modules, units, controllers, circuits, apparatus, and/or portions thereof according to any of some example embodiments (including, without limitation, any of the example embodiments of the solid-state imaging device 100, the driver 110, the pixel array unit 120, a pixel processor 140, SPAD pixel 210, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, blocks, modules, units, controllers, circuits, apparatuses, and/or portions thereof according to any of some example embodiments, and/or any portions thereof, including for example some or all operations of any of the methods and/or processes shown in any of the drawings. The processing circuitry may include electrical components such as at least one of transistors, resistors, capacitors, etc. The processing circuitry may include electrical components such as logic gates including at least one of AND gates, OR gates, NAND gates, NOT gates, etc.

While several example embodiments have been provided in the present disclosure, it should be understood that the disclosed systems, devices, and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A solid-state imaging device comprising:
a plurality of pixel blocks, wherein
each pixel block of the plurality of pixel blocks comprises a plurality of single-photon avalanche diode (SPAD) pixels configured for imaging, and
at least one SPAD pixel of the plurality of SPAD pixels includes a detection circuit configured to detect a variation of light incident on the plurality of SPAD pixels.

2. The solid-state imaging device of claim 1, wherein the at least one SPAD pixel is a detection common pixel that includes a count circuit configured to count photons incident on the at least one SPAD pixel and a detection circuit configured to detect a variation of light incident on the at least one SPAD pixel,
the detection common pixel comprises:
a counter configured to count a photon incident on the detection common pixel; and
a latch configured to latch a count value of a photon counted in a preceding frame by the counter, and
the detection circuit is configured to compare the count value of a previous frame with a count value of a current frame counted by the counter to detect the variation of light.

3. The solid-state imaging device of claim 2, wherein the detection common pixel comprises an exposure control circuit, and
the exposure control circuit is configured to, in response to the detection circuit detecting a variation of the light, indicate that a count provided by another SPAD pixel of the pixel blocks including the detection common pixel is valid.

4. The solid-state imaging device of claim 3, wherein each SPAD pixel, except the detection common pixel, of the pixel block comprises a gate unit, and
the exposure control circuit is configured to, in response to the detection circuit detecting a variation of the light, control the gate unit to output a count provided by a corresponding SPAD pixel of the plurality of SPAD pixels.

5. The solid-state imaging device of claim 1, wherein the detection circuit is shared by at least two of the plurality of pixel blocks.

6. The solid-state imaging device of claim 2, wherein the detection circuit is configured to set an upper limit value and a lower limit value of a range of a width of the count value of a previous frame and compare the count value of the current frame with the upper limit value and the lower limit value to detect a variation of light.

7. The solid-state imaging device of claim 2, wherein the detection circuit is configured to compare the count value of the current frame with the count value of the previous frame using a bit-compressed value to detect a variation of light.

8. The solid-state imaging device of claim 2, further comprising:
a first wafer including the count circuit; and
a second wafer including the detection circuit, the second wafer stacked on the first wafer.

9. The solid-state imaging device of claim 1, wherein the detection circuit is shared by at least four of the plurality of pixel blocks.

10. A solid-state imaging device comprising:
a plurality of pixel blocks, wherein
each pixel block of the plurality of pixel blocks comprises a plurality of single-photon avalanche diode (SPAD) pixels configured for imaging,
at least one SPAD pixel of the plurality of SPAD pixels includes a detection circuit configured to detect a variation of incident light, and
the other SPAD pixels of the plurality of SPAD pixels each include a count circuit configured to count an incident photon.

11. The solid-state imaging device of claim 10, wherein each SPAD pixel including the count circuit is a detection common pixel, and
the count circuit comprises:
a first avalanche photodiode; and
a first counter.

12. The solid-state imaging device of claim 11, wherein the first avalanche photodiode is configured to output a pulse signal based on the incident photon, and
the first counter is configured to count the pulse signal received from the first avalanche photodiode in synchronization with a clock signal.

13. The solid-state imaging device of claim 10, wherein the detection circuit comprises:
a first latch;
a differential circuit; and
an exposure control circuit.

14. The solid-state imaging device of claim 13, wherein the first latch is configured to latch a count value of a photon counted in a previous frame, and
the exposure control circuit is configured to, in response to the detection circuit detecting a variation of incident light, activate a count circuit of the other SPAD pixels of the plurality of SPAD pixels.

15. The solid-state imaging device of claim 13, wherein the differential circuit comprises:
a differentiator configured to compare a current frame count value with a count value of a previous frame;
a second latch configured to generate an UP signal in response to the current frame count value being greater than the count value of the previous frame; and
a third latch configured to generate a DN signal in response to the count value of the previous frame being greater than the current frame count value.

16. The solid-state imaging device of claim 10, wherein the detection circuit is shared by two or four of the plurality of pixel blocks.

17. The solid-state imaging device of claim 13, wherein each SPAD pixel, except a detection common pixel, of the pixel block comprises a gate unit, and
the exposure control circuit is configured to, in response to the detection circuit detecting a variation of incident light, control the gate unit to output a count provided by a corresponding SPAD pixel of the plurality of SPAD pixels.

18. The solid-state imaging device of claim 10, wherein the detection circuit is configured to set an upper limit value and a lower limit value of a range of a width of a count value of a previous frame and compare a count value of a current frame with the upper limit value and the lower limit value to detect a variation of light.

19. A solid-state imaging device comprising:
a driver configured to generate a plurality of signals;
a pixel array unit configured to receive the plurality of signals from the driver and including a plurality of single-photon avalanche diode (SPAD) pixels; and
a pixel processor configured to execute pixel processing to output a processing result, wherein
at least one SPAD pixel of the plurality of SPAD pixels includes a detection circuit configured to detect a variation of light incident on the at least one SPAD pixel,
at least one SPAD pixel of the plurality of SPAD pixels includes a count circuit configured to count a photon incident on the at least one SPAD pixel, and
the detection circuit is configured to compare a count value of a previous frame with a count value of a current frame to detect the variation of light.

20. The solid-state imaging device of claim 19, wherein the detection circuit is configured to compare the count value of the current frame with the count value of the previous frame by using a bit-compressed value to detect a variation of light.
